(19) United States
(12) Patent Application Publication
(10) Pub. No.: US 2024/0343320 A1
(43) Pub. Date: Oct. 17, 2024

(54) LATERAL REAR REGION OF A MOTOR VEHICLE COMPRISING AN AIR DIRECTING DEVICE, AND MOTOR VEHICLE

(71) Applicant: Dr. Ing. h.c. F. Porsche Aktiengesellschaft, Stuttgart (DE)

(72) Inventors: Dominik Beierl, Korntal-Münchingen (DE); Bernd Herrmann, Ehningen (DE); Joachim Paul, Benningen a.N. (DE); Okan Gönüldinc, Ostfildern (DE); Moritz Zeh, Stuttgart (DE)

(73) Assignee: Dr. Ing. h.c. F. Porsche Aktiengesellschaft, Stuttgart (DE)

(21) Appl. No.: 18/632,357

(22) Filed: Apr. 11, 2024

(30) Foreign Application Priority Data
Apr. 12, 2023 (DE) 102023109208.1

(51) Int. Cl. B62D 35/00; F16C 1/10

(52) U.S. Cl. CPC B62D 35/007; F16C 1/10

(57) ABSTRACT

A lateral rear region of a vehicle includes a rear body member, which extends at least behind a rear wheel housing of the vehicle, and an air directing device. An air guidance element of the air directing device is displaceable relative to the rear body member between a rest position retracted into the lateral rear region and a service position extended out of the same such that, in the retracted rest position, a flow guide surface of the air guidance element is covered by the rear body member and that, in the extended operating position, the flow guide surface of the air guidance element is rearwardly displaced from the rear body member at least in the longitudinal direction of the motor vehicle. The air directing device includes a guide and drive unit, which guides and drives the air guidance element during the displacement relative to the rear body member.

### CROSS-REFERENCE TO RELATED APPLICATION

This application claims priority to German Patent Application No. 10 2023 109 208.1, filed Apr. 12, 2023, the content of such application being incorporated by reference herein in its entirety.

### FIELD OF THE INVENTION

The invention relates to a lateral rear region of a motor vehicle comprising an air directing device. The invention further relates to a motor vehicle.

### BACKGROUND OF THE INVENTION

A wide variety of motor vehicle air directing devices are known in practice. Air directing devices that are associated with a lateral region of a motor vehicle and used to guide flow in that location are also referred to as sideblades.

DE 10 2019 207 906 A1, which is incorporated by reference herein, discloses a motor vehicle having a sideblade which is arranged above a rear wheel, behind a window of a rear vehicle door.

DE 20 2011 005 504 U1, which is incorporated by reference herein, discloses a motor vehicle having an air directing element, which extends between a front wheel and a rear wheel and is used to guide flow in that location.

DE 10 2018 123 487 A1, which is incorporated by reference herein, discloses a motor vehicle comprising an air directing device designed as a wheel spoiler.

DE 10 2019 114 113 A1, DE 10 2007 003 601 A1 and FR 3 001 192 A1, which are incorporated by reference herein, disclose further art.

### SUMMARY OF THE INVENTION

The invention relates to a lateral rear region of a motor vehicle comprising an air directing device that is used to guide flow in the lateral rear region behind a rear wheel housing of the motor vehicle. A lateral rear region comprises an air directing device that is compact in construction, the air guidance element of which can be reliably displaced relative to a rear body member of the rear region and that enables optimum flow guidance in the lateral rear region.

The lateral rear region according to aspects of the invention comprises a rear body member, which extends at least behind a rear wheel housing of the motor vehicle. The lateral rear region according to aspects of the invention further comprises an air directing device. The air directing device of the lateral rear region according to aspects of the invention comprises an air guidance element, which is displaceable relative to the rear body member between a rest position retracted in the lateral rear region and an operating position extended out of the lateral rear region, in the retracted rest position, a flow guide surface of the air guidance element is covered by the rear body member and that, in the extended operating position, the flow guide surface is displaced rearward against the rear body member, at least in the longitudinal direction of the motor vehicle. The air directing device of the lateral rear region according to aspects of the invention further comprises a guide and drive unit, which guides and drives the air guidance element relative to the rear body member during displacement, whereby a drive of the guide and drive unit is designed as a cable pull drive with a drive cable, which is preferably wound at least twice around a drive drum of the cable pull drive and is driveable by the drive drum. The invention enables optimal flow guidance in the lateral rear region of the motor vehicle behind the rear wheel housing thereof. The lateral rear region according to aspects of the invention comprises the air directing device for this purpose. The air directing device comprises the air guidance element and the guide and drive unit. The air guidance element is displaceable between the retracted rest position and the extended operating position using the guide and drive unit. A cable pull drive with a drive cable, which is wound around a drive drum and is driveable by the drive drum, serves as the drive of the guide and drive unit. Such an air directing device comprising a cable pull drive has a compact design, is robust, and thus enables reliable displacement of the air guidance element of the air directing device.

The guide and drive unit preferably comprises at least one fixed guide rail and at least one sliding block that can be displaced relative to the fixed guide rail, whereby the cable pull drive displaces the respective sliding block relative to the respective guide rail and, via the respective sliding block, displaces the air guidance element relative to the rear vehicle body region. The drive cable of the cable act on the respective sliding block. The respective sliding block can be displaced relative to the fixed guide rail via the cable pull drive. As a result, the air guidance element is able to be reliably transitioned between the rest position and the operating position in a compact design of the air directing device, and thus the rear region.

Preferably, the drive cable of the cable pull drive is guided to both sides of the respective guide rail on a deflection drum, is wound around the drive drum in a region between the deflection drums, and is guided crosswise to one side of the deflection drum. This enables a particularly advantageous transfer of a driving force onto the respective sliding block, which can be displaced along the guide rail. Given a compact design, the air guidance element can be reliably transitioned between the rest position and the operating position of the air directing device, and thus the rear region.

The flow guide surface of the air guidance element is preferably displaced rearward in the operating position from the rest position on the one hand when viewed in the longitudinal direction of the motor vehicle and outwards when viewed in the transverse direction of the motor vehicle on the other hand, preferably such that in the operating position, the flow guide surface of the air guidance element is flush with an outer surface of the rear body member, which is immediately connected to the flow guide surface in the front. A particularly advantageous flow direction via the air directing device of the lateral rear region behind the rear wheel housing of the motor vehicle is thereby possible in the lateral rear region.

### BRIEF DESCRIPTION OF THE DRAWINGS

Preferred embodiments of the invention follow from the dependent claims and the subsequent description. Without being restricted thereto, exemplary embodiments of the invention will be explained in greater detail with reference to the drawings.

FIGS. 1a, 1b depict two views of a lateral rear region of a motor vehicle according to the present invention in a first state with an air directing device in a retracted resting position,

FIGS. 2a, 2b depict two views of the lateral rear region of the motor vehicle according to aspects of the invention in a second state with an air directing device in an intermediate position between the retracted rest position and an extended operating position,

FIGS. 3a, 3b depict two views of the lateral rear region of the motor vehicle according to aspects of the invention in a third state with an air guiding device in the extended operating position,

FIGS. 4a, 4b depict two views of the air guiding device in the retracted rest position,

FIGS. 5a, 5b depict two views of the air guiding device in the intermediate position,

FIGS. 6a, 6b depict two views of the air guiding device in the extended operating position,

FIGS. 7a, 7b depict drive-side details of the lateral rear region according to aspects of the invention,

FIGS. 8a, 8b depict two further views of the lateral rear region of the motor vehicle according to aspects of the invention in the retracted rest position and in the extended operating position for clarification of the flow guide.

### DETAILED DESCRIPTION OF THE INVENTION

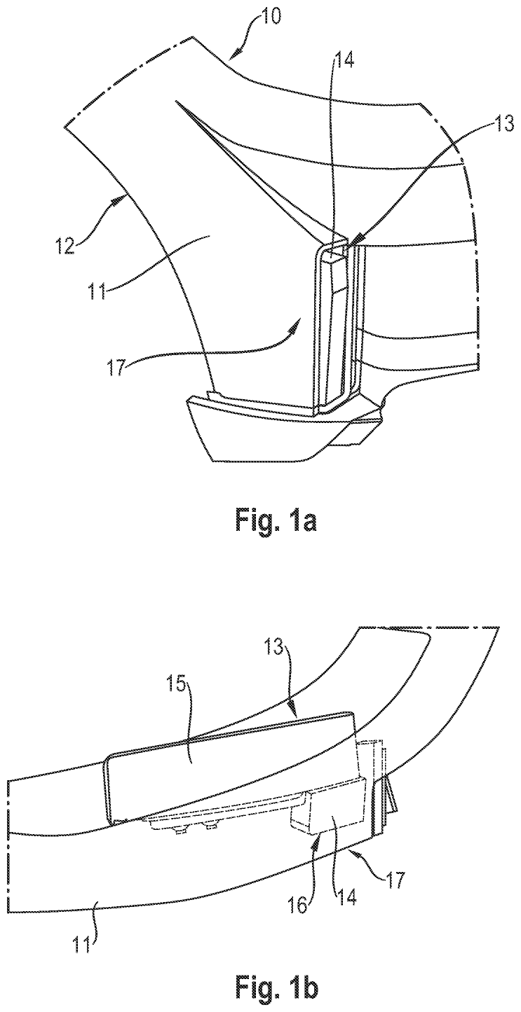

FIGS. 1a to 3b show a detail from a lateral rear region 10 of a motor vehicle according to aspects of the invention. From the lateral rear region 10, a rear body member 11 is shown that extends in the lateral rear region 10 of the motor vehicle at least behind a rear wheel house 12 of the motor vehicle.

Such a lateral rear region 10 is formed on both sides of the motor vehicle.

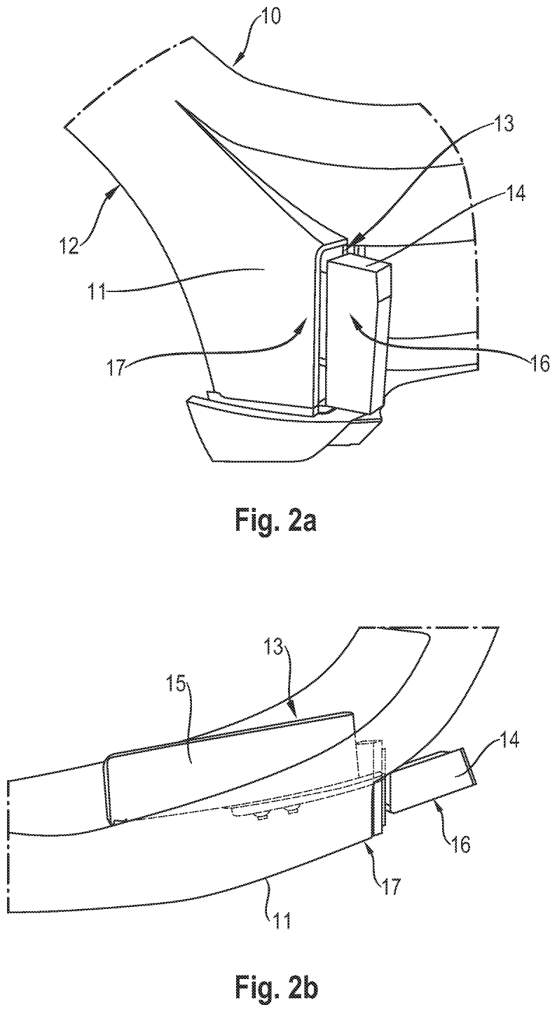

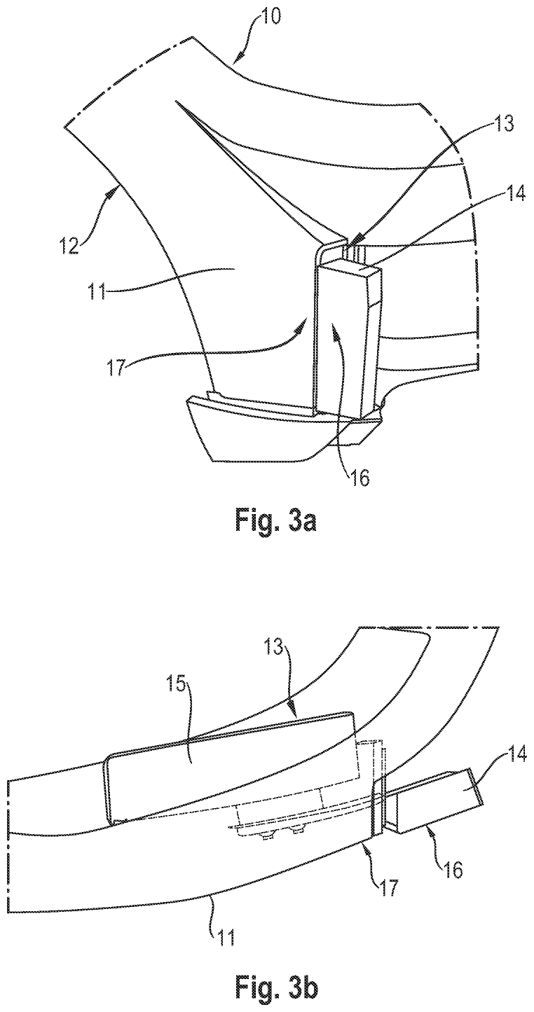

The lateral rear region 10 comprises an air directing device 13. The air directing device 13 comprises an air guidance element 14 as well as a guide and drive unit 15. By means of the guide and drive unit 15, the air guidance element 14 can be displaced relative to the rear body member 11 between a rest position retracted in the lateral rear region 10 (see FIGS. 1a, 1b) and an operating position extended from the same (see FIGS. 3a, 3b), whereby FIGS. 2a, 2b show an intermediate position of the air guidance element 14 between the retracted rest position in FIG. 1a, 1b and the retracted rest position in FIGS. 3a, 3b.

The guide and drive unit 15 is completely covered by the rear body member 11 and mounted in or at the lateral rear region 10 such that the guide and drive unit 15 is fixed to the rear body member 11. The air guidance element 14 is displaceable relative to the guide and drive unit 15 as well as relative to the rear body member 11.

The air guidance element 14 comprises a flow guide surface 16. In the retracted resting position (FIGS. 1a, 1b) of the air guidance element 14, the flow guide surface 16 thereof is retracted into the lateral rear region 10 and is covered by the rear body member 11. In the extended operating position (FIGS. 3a, 3b) of the air guidance element 14, the flow guide surface 16 is extended out of the lateral rear region 10 and is not covered by the rear body member 11, whereby, in the exemplary embodiment shown, the flow guide surface 16 of the air guidance element 14 in the extended operating position is displaced rearwardly from the retracted resting position when viewed on the one hand in the longitudinal direction of the motor vehicle and, on the other hand, outwardly when viewed in the transverse direction of the motor vehicle.

In the intermediate position shown in FIGS. 2a, 2b, the flow guide surface 16 is only displaced rearward when viewed in the longitudinal direction of the motor vehicle. In the extended operating position (FIGS. 3a, 3b), the same is also displaced outwardly when viewed in the transverse direction of the motor vehicle.

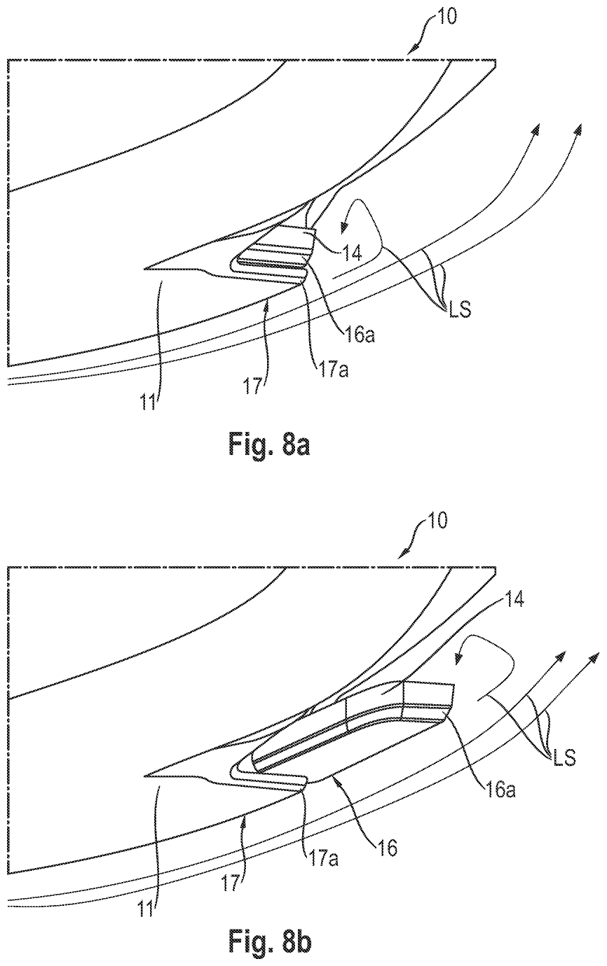

In the extended operating position of the air guidance element 14 (FIGS. 3a, 3b), the flow guide surface 16 of the air guidance element 14 is in particular displaced outwards when viewed in the transverse direction of the motor vehicle such that the same extends flush with an outer surface 17 of the rear body member 11, which is immediately connected to the flow guide surface 16 in the front. FIGS. 8a and 8b also show the air guidance element 14 of the air directing device 13 in two different states, i.e., in FIG. 8a in the retracted rest position and in FIG. 8b in the extended operating position, whereby FIG. 8b in turn shows the flush transition between the flow guide surface 16 of the air guidance element 14 and 30 the front and the same immediately subsequent outer surface 17 of the rear body member 11. Also shown in FIGS. 8a and 8b is an air flow LS in the region of the rear body member 11, i.e., in FIG. 8a an air flow LS in air guidance element 14 displaced to the retracted rest position and in FIG. 8b air guidance element 14 displaced to the extended operating position.

Whereas in FIG. 8a the air flow LS debonds in the region of an edge 17a of the outer surface 17 of the rear body member 11, in FIG. 8b this debonding of the air flow LS takes place in the region of an edge 16a of the flow guide surface 16 of the air guidance element 14. In FIG. 8a, this edge 16a of the flow guide surface 16 is occluded on the outside of the edge 17a of the outer surface 17 of the rear body member 11.

In the retracted rest position, the flow guide surface 16 of the air guidance element 14 is fully retracted into the lateral rear region 10 and is covered externally from the outer surface 17 of the rear body member 11.

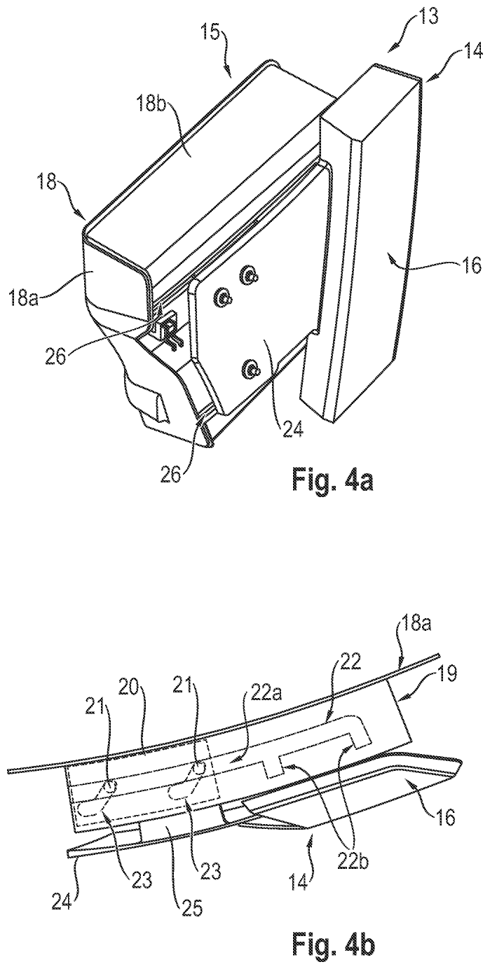

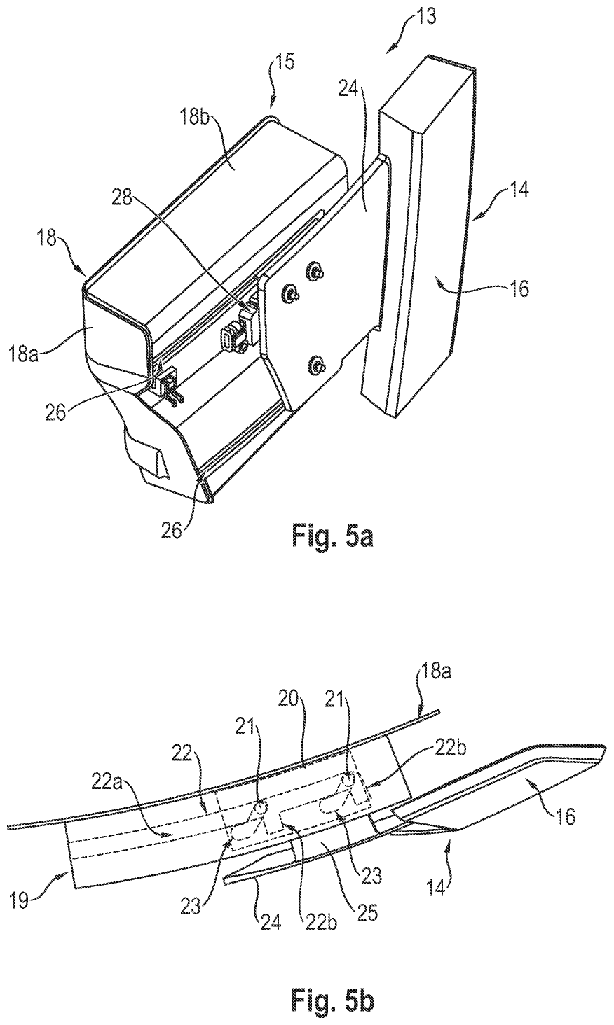

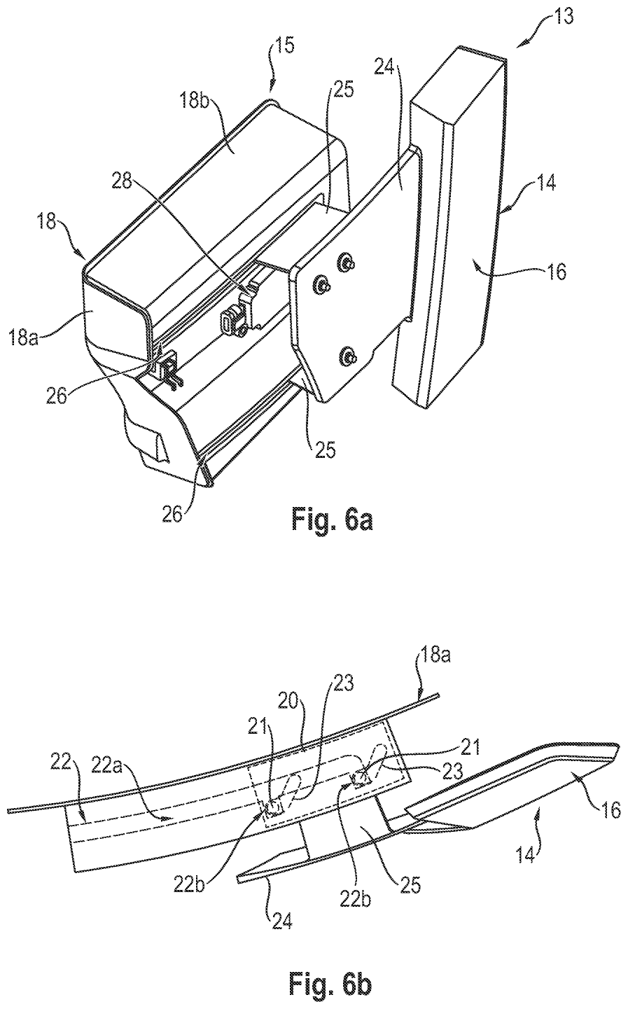

FIGS. 4a to 6b show further details of the air directing device 13 of the lateral rear region 10 according to aspects of the invention, whereas FIGS. 4a to 6b show the air directing device 13 in the sole representation, i.e., FIGS. 4a, 4b in the retracted rest position, FIGS. 6a, 6b in the extended operating position and FIGS. 5a, 5b in an intermediate position between the extended operating position and the extended operating position.

The guide and drive unit 15 of the air directing device 13, which is used to displace the air guidance element 14 between the retracted rest position and the extended operating position, has a housing 18 consisting of a first housing member 18a and a second housing member 18b. Both housing members 18a, 18b are respectively shown in FIGS. 4a, 5a, 6a. In FIGS. 4b, 5b, 6b, the respective second housing member 18b is not shown.

At least one fixed guide rail 19 of the guide and drive unit 15 is received in the housing 18.

In particular, two such guide rails 19 are arranged in the housing 18, i.e., an upper fixed guide rail 19 and a lower fixed guide rail 19. In FIGS. 4b, 5b, 6b, the respective upper fixed guide rail 19 is visible.

A sliding block 20, which can be displaced relative to the respective fixed guide rail 19, cooperates with the respective fixed guide rail 19. The air guidance element 14 is guided with at least one guide bolt 21 on a respective guide rail 19 and on a respective sliding block 20. Preferably, two upper guide bolts 21 of the air guidance element 14 cooperate with the upper fixed guide rail 19 and the upper sliding block 20. With the lower fixed guide rail 19 and the lower sliding block 20 (not visible in FIGS. 4b, 5b, 6b), a single lower guide bolt 21 of the air guidance element 14 preferably cooperates.

The guide bolts 21 engage a guide groove 22 of the respective guide rail 19 and a respective guide groove 23 of the respective sliding block 20. Via a drive 28 of the guide and drive unit 15, the respective sliding block 20 can be displaced relative to the respective guide rail 19, and via the respective sliding block 20, the air guidance element 14 can be displaced relative to the rear body member 11.

If the air guidance element 14 is intended to be displaced from the retracted rest position of FIGS. 4a, 4b to the extended operating position of FIGS. 6a, 6b, the respective sliding block 20 is first translated along the respective guide rail 19, whereby the guide bolts 21 are or are to be displaced in a first guide section 22a of the respective guide groove 22 of the respective guide rail 19.

If the or one of the guide bolts 21 comes into contact with a limitation of this first guide section 22a of the guide groove 22 of the respective guide rail 19, the guide bolts 21 can or can no longer be displaced within the first guide section 22a. In this case, the air guidance element 14 then occupies the intermediate position in FIGS. 5a, 5b.

If the respective sliding block 20 is subsequently translationally displaced further relative to the respective guide rail 19, the guide pin or guide pins 21, which are also guided in the at least one guide groove 23 of the sliding block 20, is or are pressed via the respective sliding block 20, namely the at least one guide groove 23 thereof, into a respective second guide section 22b of the guide groove 22 of the respective guide rail 19, namely outwards in the transverse direction of the motor vehicle. This is caused by the curved contour of the at least one guide groove 23 of the respective sliding block 20, which is curvedly contoured and extends obliquely to the guide sections 22a, 22b of the guide groove 22 of the respective guide rail 19.

Thus, when displacing the air guidance element 14 from the retracted rest position shown in FIG. 4b to the extended operating position shown in FIG. 6b, the guide bolts 21 of the air guidance element 14 are first displaced along the first guide sections 22a of the guide grooves 22 of the guide rails 19 in the longitudinal direction or primarily in the longitudinal direction of the motor vehicle until this is not possible. In this case, the air guidance element 14 then occupies the intermediate position of FIG. 5b and is displaced rearward in the longitudinal direction of the vehicle. The first guide portions 22a of the guide grooves 22 of the guide rails 19 extend in the longitudinal direction or primarily in the longitudinal direction of the motor vehicle. The same can include an acute angle of up to 15° or up to 10° or up to 5° with the longitudinal direction of the motor vehicle. By further relative movement of the respective sliding block 20 rearward with respect to the respective guide rail 19, the guide bolts 21 are then moved along the guide grooves 23 of the sliding blocks 20, as well as moved outwards in the transverse direction of the motor vehicle and along the second guide sections 22b of the guide grooves 22 of the guide rails 19, which extend in the transverse direction of the motor vehicle, or mainly in the transverse direction of the motor vehicle. The air guidance element 14 is then transferred to the operating position of FIG. 6b. The second guide portions 22b are perpendicular to the first guide portions 22a.

The air directing device 13 or the air guidance element 14 comprises a tab 24, into which protrusions 25 engage. The tab 24 extends forwardly from the air guidance element 14 in the longitudinal vehicle direction, is displaceable together with the air guidance element 14 and is always covered by the rear body member 11. The tab 24 is a “part” of the air guidance element 14, but does not provide the flow guide surface 16 of the air guidance element 14. The protrusions 25 extend in the transverse direction of the motor vehicle from the tab 24. The guide bolts 21 are formed or arranged on the protrusions 25. The protrusions 25 and guide bolts 21 are also “components” of the air guidance element 14.

The protrusions 25 extend into the housing 18 starting from a side of the tab 24 facing away from the flow guide surface 16 with portions through slots 26 in the housing member 18b. The guide bolts 21 are formed or arranged on the portions of these protrusions 25 positioned in the housing 18.

A superimposed double guide is provided via the interaction of the respective guide rail 19 with the respective sliding block 20. Firstly, displacement is performed in the longitudinal direction or primarily in the longitudinal direction, then displacement is performed in the transverse direction or primarily in the transverse direction.

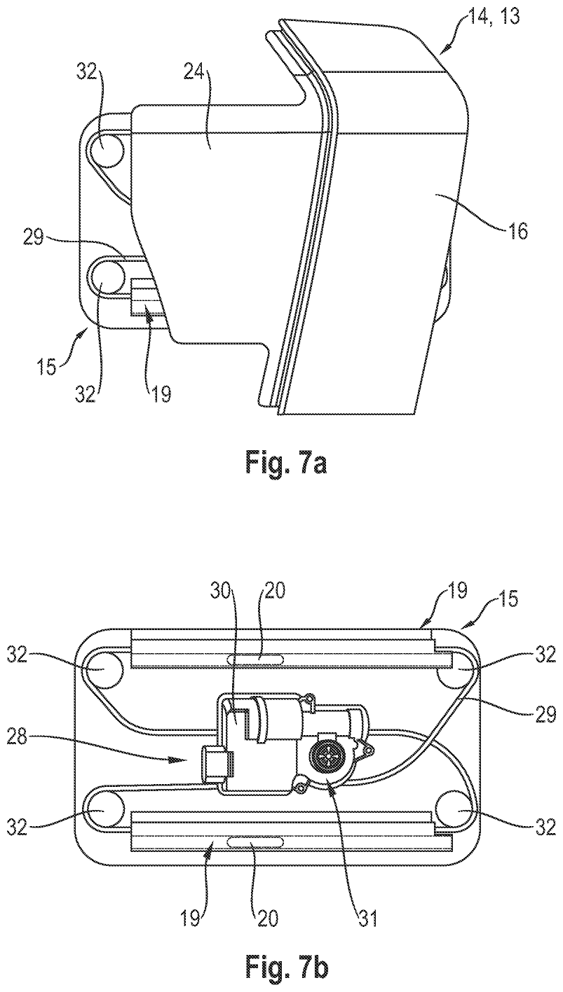

FIGS. 7a and 7b show further details of the invention, i.e., details of the guide and drive unit 15, whereby FIG. 7a additionally shows the air directing device 13. Shown in FIG. 7b in particular are the two guide rails 19 and the two sliding blocks 20, which can be displaced along the guide rails 19.

A cable pull drive comprising a drive cable 29 and comprising a drive drum 31 covered by a housing 30 that can be rotated by a drive motor serves as the drive 28. The drive cable 29 is preferably wound several times, in particular two times, around the drive drum 31 of the cable pull drive and can be driven by the drive drum 31, which can in turn be driven by the drive motor designed as an electric motor. The drive cable 29 engages the respective sliding block 20, preferably in that the drive cable 29 is crimped with the respective sliding block 20, whereby the respective sliding block 20 is displaceable relative to the respective guide rail 19 via the drive cable 29. As previously explained, the drive cable 29 is preferably wound around the drive drum 31 at least two times, whereby the drive cable 29 is guided to both sides of each guide rail 19 on a respective deflection drum 32. In a region between the diverting drums 32, the drive cable 29 is wound around the drive drum 31 and guided crosswise to one side of the drive drum 31.

This enables a particularly advantageous, i.e., robust and reliable, displacement of the sliding blocks 20 along the guide rail 19 and thus the air guidance element 14 relative to the rear body member 11 using the cable pull drive in a compact design. The cable pull drive preferably forms a closed cable pull drive.

Accordingly, the guide and drive unit 15 comprises the cable pull drive 28 as well as the two fixed guide rails 19 and the two sliding blocks 20. The sliding blocks 20 are connected to the drive cable 29 of the cable pull drive 28 of the guide and drive unit 15, in particular by crimping. By driving the drive drum 31 of the cable pull drive 28 in different directions of rotation, the drive cable 29 can be displaced in different translational directions to displace the sliding bricks 20 relative to the guide rails 19 and thus ultimately displace the air guidance element 14 of the air directing device 13 between the retracted rest position and the extended operating position.

Via the cable pull drive 28, the sliding elements 20 can be displaced relative to the respective guide rail 19 and thus the air guidance element 14 relative to the rear body member 11, i.e., in both the longitudinal direction and the transverse direction of the motor vehicle. It should be noted at this point that the displacement of the air guidance element 14 is also preferred in the transverse direction, but it is also possible to only displace the air guidance element 14 in the longitudinal direction of the motor vehicle.

With the invention, a reliable and robust displacement of the air guidance element 14 of the air directing device 13 relative to the rear body member 11 of the lateral rear region 10 is possible. No forces in the high direction of the motor vehicle act on the guide rails 19 and sliding blocks 20 and thus on the air guidance element 14.

What is claimed is:

1. A lateral rear region of a motor vehicle comprising:
a rear body member extending at least behind a rear wheel housing of the motor vehicle; and
an air directing device including an air guidance element that is displaceable relative to the rear body member between a rest position retracted into the rear body member and an operating position extended out of the rear body member,
wherein, in the rest position, a flow guide surface of the air guidance element is covered by the rear body member and, in the operating position, the flow guide surface of the air guidance element is displaced rearward relative to the rear body member, at least in a longitudinal direction of the motor vehicle,
wherein the air directing device comprises a guide and drive unit which guides and drives the air guidance element during the displacement relative to the rear body member,
wherein a drive of the guide and drive unit comprises a cable pull drive including a drive cable, which is wound around a drive drum of the cable pull drive and is configured to be driven by the drive drum.

2. The lateral rear region according to claim 1, wherein the cable pull drive is a closed cable pull drive and the drive cable is closed.

3. The lateral rear region according to claim 1, wherein the guide and drive unit comprises at least one fixed guide rail and at least one sliding block displaceable relative to the fixed guide rail, wherein the cable pull drive displaces the respective sliding block relative to the respective guide rail and displaces the air guidance element via the respective sliding block relative to the rear body member.

4. The lateral rear region according to claim 3, wherein the drive cable engages into the respective sliding block and displaces the respective sliding block relative to the respective guide rail.

5. The lateral rear region according to claim 3, wherein the drive cable is guided to both sides of the respective guide rail on a deflection drum, wound around the drive drum in a region between the deflection drums, and crossed to one side of the drive drum.

6. The lateral rear region according to claim 3, wherein the air guidance element engages via at least one guide bolt into a guide groove of the respective guide rail and into at least one guide groove of the respective sliding block.

7. The lateral rear region according to claim 1, wherein the flow guide surface of the air guidance element is displaced rearward in the operating position from the rest position when viewed on the one hand in the longitudinal direction of the motor vehicle and, on the other hand, outwardly when viewed in a transverse direction of the motor vehicle, such that in the operating position, the flow guide surface of the air guidance element is flush with an outer surface of the rear body member.

8. The lateral rear region according to claim 6, wherein the guide groove of the respective guide rail comprises (i) a first guide section for the displacement of the at least one guide bolt, and thus the air guidance element, in the longitudinal direction or primarily in the longitudinal direction of the motor vehicle, and (ii) at least a second guide section for the displacement of the at least one guide bolt, and thus the air guidance element, in the transverse direction or primarily in the transverse direction of the motor vehicle.

9. The lateral rear region according to claim 8, wherein the at least one guide groove of the respective sliding block is curvedly contoured and extends obliquely to the guide sections of the respective guide rail.

10. The lateral rear region according to claim 3, wherein the at least one fixed guide rail comprises an upper fixed guide rail and a lower fixed guide rail, wherein the at least one sliding block comprises an upper sliding block and a lower sliding block, wherein a respective sliding block cooperates with each guide rail, and wherein two upper guide bolts are inserted into the guide grooves of the upper fixed guide rail and the upper sliding block, and wherein a single lower guide bolt is inserted into the guide grooves of the lower fixed guide rail and the lower sliding block.

11. The lateral rear region according to claim 10, wherein the guide and drive unit comprises a housing, wherein the at least one fixed guide rail and the at least one sliding block are arranged in an interior space of the housing, wherein protrusions of the air guidance element extend from a side of the air guidance element facing away from the flow guide surface via portions extending into the housing through slots in the housing, and wherein the guide bolts of the air guidance element are formed or arranged on the portions of the protrusions of the air guidance element arranged in the housing.

12. A motor vehicle comprising two lateral rear regions according to claim 1.
